(19) United States
(12) Patent Application Publication
(10) Pub. No.: US 2026/0340251 A1
(43) Pub. Date: Oct. 29, 2026

(54) METHODS TO DERIVE FAILURE-IN-TIME RATES OF INTER-CONDUCTOR DIELECTRIC TIME-DEPENDENT DIELECTRIC BREAKDOWN FOR INTEGRATED CIRCUITS

(71) Applicant: TAIWAN SEMICONDUCTOR MANUFACTURING COMPANY LTD., HSINCHU (TW)

(72) Inventors: CHUNG-CHIEH YANG, HSINCHU COUNTY (TW); MING-YIH WANG, HSIN-CHU (TW)

(21) Appl. No.: 19/732,546

(22) Filed: Jul. 6, 2026

Related U.S. Application Data
(63) Continuation of application No. 18/985,061, filed on Dec. 18, 2024.
(60) Provisional application No. 63/682,358, filed on Aug. 13, 2024.

(51) Int. Cl. G06F 30/367; G06F 30/392; G06F 30/398; G06F 111/20; G06F 119/02

(52) U.S. Cl. CPC G06F 30/367; G06F 30/392; G06F 30/398; G06F 2111/20; G06F 2119/02

(57) ABSTRACT

The present disclosure provides a method which includes the following steps: obtaining an operation waveform of an integrated circuit which includes a plurality of cells; performing state mapping to each cell within the integrated circuit based on the obtained operation waveform; calculating state duties of one or more operational voltage states of each cell within the integrated circuit; calculating effective physical information of each inter-conductor dielectric within each cell using the state duties of the one or more operational voltage states of the respective cell; and calculating a failure-in-time rate of the integrated circuit from the effective physical information of each inter-conductor dielectric within each cell.

### CROSS-REFERENCE TO RELATED APPLICATION(S)

This application is a Continuation of pending U.S. patent application Ser. No. 18/985,061, filed on Dec. 18, 2024, which claims the benefit of U.S. Provisional Application No. 63/682,358, filed Aug. 13, 2024, the entire disclosure of which are incorporated by reference herein.

### BACKGROUND

As technology advances, the decreasing pitch and increasing gate count continue to constrain the reliability margins of semiconductor devices. Additionally, failures related to inter-metal dielectric (IMD) time-dependent dielectric breakdown (TDDB), occurring between “VIAs to conductors” or “conductors to conductors,” have become increasingly significant due to the reduced dimensions of the semiconductor devices.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of an IC design system 100 in accordance with some embodiments.

FIG. 2 is a flowchart of a method for developing TDDB profiles of IMD objects for each cell within cell libraries in accordance with some embodiments of the present disclosure.

FIG. 3A is a partial cross section of an integrated circuit in accordance with some embodiments of the present disclosure.

FIG. 3B is a partial cross section of an integrated circuit in accordance with still some embodiments of the present disclosure.

FIG. 4A is a diagram of a two-input NAND gate in accordance with some embodiments of the present disclosure.

FIG. 4B is a top layout view of metal layer 0 of the two-input NAND gate in FIG. 4A.

FIG. 4C is another top layout view of metal layer 0 of the two-input NAND gate in FIG. 4A.

FIG. 5 is a flowchart of a method for calculating a failure-in-time (FIT) rate of an integrated circuit under a specific operation mode in accordance with some embodiments of the present disclosure.

FIG. 6A is a diagram of three NAND gates within an integrated circuit in accordance with some embodiments of the present disclosure.

FIGS. 6B to 6D are waveform diagrams of internal operation waveforms of the respective NAND gates in FIG. 6A.

FIG. 7 is a waveform diagram of an internal operational waveform of the NAND gate #2 with propagation delay in accordance with the embodiment of FIG. 6A.

FIG. 8A is a diagram illustrating operations of an integrated circuit across a predetermined period in accordance with some embodiments of the present disclosure.

FIG. 8B is a diagram illustrating different operation modes and corresponding operation years and usage weightings of the integrated circuit in accordance with the embodiment of FIG. 8A.

FIG. 9 is a flowchart of a method for calculating a failure-in-time (FIT) rate of an integrated circuit under multiple operation modes in accordance with some embodiments of the present disclosure.

FIG. 10 is a flowchart of a method for performing TDDB benchmarking of cells within a cell library using the TDDB cell profiles in accordance with some embodiments of the present disclosure.

FIG. 11 is a block diagram of an IC manufacturing system 1100, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

In some embodiments, a method for constructing a time-dependent dielectric breakdown (TDDB) cell profile for a cell within a cell library is disclosed. The TDDB cell profile is capable of documenting all valid voltage states of each cell, as well as the stress voltage and its stress direction across each inter-conductor dielectric within each cell, in addition to the physical information of each inter-conductor dielectric. The TDDB cell profile of each cell within an integrated circuit can facilitate the derivation of an accurate failure-in-time (FIT) rate of the integrated circuit based on realistic operational waveforms under one or more operational modes. Moreover, the TDDB cell profile can assist in establishing a benchmark of FIT rates for the cells within a cell library, allowing for the identification and strategic addressing of cells with the highest FIT rates to ensure the reliability of the cells within the cell library. This approach ultimately provides a reliable cell library during the design phase of the integrated circuit.

In integrated circuit (IC) design, a variety of functions are integrated into one chip, and an application specific integrated circuit (ASIC) or system on a chip (SOC) cell based design is often used. In this approach, a library of known functions is provided, and after the functional design of the device is specified by choosing and connecting these standard functions, and proper operation of the resulting circuit is verified using electronic design automation (EDA) tools, the library elements are mapped on to predefined layout cells, which contain prefigured elements such as transistors. The cells are chosen with the particular semiconductor process nodes and parameters in mind and create a process-parameterized physical representation of the design. The design flow continues from that point by performing placement and routing of the local and global connections needed to form a layout of the completed design using the standard cells.

After the layout is completed, various analysis procedure are performed and the layout is verified to check whether the layout violates any of the various constraints or rules. For example, design rule check (DRC), layout versus schematic (LVS) and electric rule check (ERC) are performed. The DRC is a process of checking whether the layout is successfully completed with a physical measure space according to the design rule, and the LVS is a process of checking whether the layout meets a corresponding circuit diagram. In addition, the ERC is a process of for checking whether devices and wires/nets are electrically well connected therebetween. After design rule checks, design rule verification, timing analysis, critical path analysis, static and dynamic power analysis, and final modifications to the design, a tape out process is performed to produce photomask generation data. This photomask generation (PG) data is then used to create the optical masks used to fabricate the semiconductor device in a photolithographic process at a wafer fabrication facility (FAB). In the tape out process, the database file of the IC is used to make various layers of masks for integrated circuit manufacturing. In some embodiments, the database file is a Graphic Database System (GDS) file (e.g., a GDS file or a GDSII file). Furthermore, the GDS file is the industry's standard format for transfer of IC layout data between design tools of different vendors.

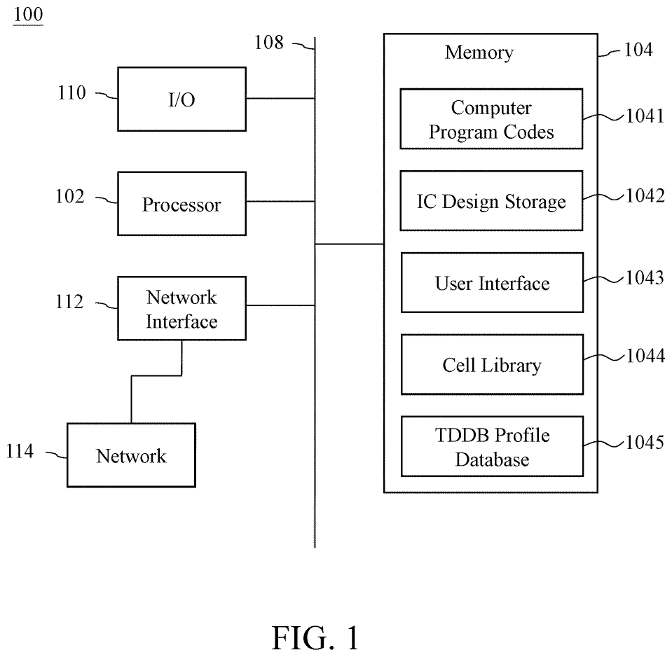

FIG. 1 is a block diagram of an IC design system 100 in accordance with some embodiments. Methods described herein for designing IC layout diagrams and adaptively generating power delivery networks in accordance with one or more embodiments are implementable, for example, using IC design system 100, in accordance with some embodiments. In some embodiments, IC design system 100 is an APR (automatic placement and routing) system, includes an APR system, or is part of an APR system, usable for performing an APR method.

In some embodiments, IC design system 100 is a general purpose computing device including a hardware processor 102 and memory 104. Memory 104 is a non-transitory, computer-readable storage medium. Memory 104, amongst other things, is encoded with, i.e., stores, computer program codes 1041, i.e., a set of executable instructions. Execution of computer program codes 1041 by hardware processor 102 represents (at least in part) an EDA tool which implements a portion or all of a method, e.g., methods 500, 900, and 1000 described later (hereinafter, the noted processes and/or methods).

Processor 102 is electrically coupled to memory 104 via bus 108. Processor 102 is also electrically coupled to an I/O interface 110 through bus 108. Network interface 112 is also electrically connected to processor 102 through bus 108. Network interface 112 is connected to a network 114, so that processor 102 and memory 104 are capable of connecting to external elements via network 114. Processor 102 is configured to execute computer program codes 1041 encoded in memory 104 in order to cause IC design system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit, but the present disclosure is not limited thereto.

In one or more embodiments, memory 104 is an electronic, magnetic, optical, electromagnetic, infrared, and/or a semiconductor system (or apparatus or device). For example, memory 104 may be or include a non-volatile memory such as a semiconductor or solid-state memory, a hard disk drive (HDD), a magnetic tape, a removable computer diskette, a random access memory (RAM), a read-only memory (ROM), a rigid magnetic disk, an optical disk, SD memory card, memory sticks, ferroelectric random access memory (FeRAM), resistive random access memory (RRAM), etc., but the present disclosure is not limited thereto. In one or more embodiments using optical disks, memory 104 includes a compact disk-read only memory (CD-ROM), a compact disk-read/write (CD-R/W), and/or a digital video disc (DVD).

In one or more embodiments, memory 104 stores computer program codes 1041 configured to cause IC design system 100 (where such execution represents (at least in part) the EDA tool) to be usable for performing a portion or all of the noted processes and/or methods. In one or more embodiments, memory 104 also stores information which facilitates performing a portion or all of the noted processes and/or methods. In one or more embodiments, memory 104 includes IC design storage 1042 configured to store one or more IC layout diagrams generated during the design phase of one or more IC designs.

IC design system 100 includes I/O interface 110. I/O interface 110 is coupled to external circuitry. In one or more embodiments, I/O interface 110 includes a keyboard, keypad, mouse, trackball, trackpad, touchscreen, and/or cursor direction keys for communicating information and commands to processor 102.

In some embodiments, IC design system 100 also includes network interface 112 coupled to processor 102. Network interface 112 allows IC design system 100 to communicate with network 114, to which one or more other computer systems are connected. In some embodiments, network interface 112 includes wireless network interfaces and/or wired network interface. The wireless network interface may include Wi-Fi (802.11), Global System for Mobile Communications (GSM), Enhanced Data rates for GSM Evolution (EDGE), Wideband Code Division Multiple Access (WCDMA), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless Universal Serial Bus (USB) protocols, etc. The wired network interfaces may include Ethernet, Universal Serial Bus (USB), Inter Integrated Circuit (I2C), Serial Peripheral Interface (SPI), etc., but the present disclosure is not limited thereto. In one or more embodiments, a portion or all of noted processes and/or methods, is implemented in two or more IC design systems 100.

In some embodiments, IC design system 100 is configured to receive information through I/O interface 110. The information received through I/O interface 110 includes one or more of instructions, data, design rules, libraries of standard cells, and/or other parameters for processing by processor 102. The information is transferred to processor 102 via bus 108. IC design system 100 is configured to receive information related to a user interface through I/O interface 110. The information is stored in memory 104 as user interface (UI) 1043.

In some embodiments, the cell library 1044 may include one or more cell libraries each storing a plurality of cells, intellectual property (IP), and/or chips (e.g., integrated circuits) that can be used in an automatic placing and routing (APR) process. For example, a cell may refer to a standard cell, an analog cell, a memory cell (e.g., SRAM bit cell), an input/output (I/O) cell, or a circuit block. Additionally, an IP may include one or more cells, while a chip may include one or more IPs. In some embodiments, each standard cell may be a macro including one or more logic gates. Examples of a macro including one logic gate can be an NOT, AND, OR, NAND, NOR, XOR gate, etc. Examples of a macro including plural logic gates or a CMOS complex gate can be a 2-bit full adder, a D flip-flop, a latch, a buffer, and-or-invert gate (AOI), or-and-inverter gate (OAI), etc. In some embodiments, each cell in the cell library includes a plurality of transistors. The transistors can be electrically connected through a plurality of metal layers and vias that are encapsulated by a dielectric. Additionally, a transistor may include components such as a gate oxide, a metal over gate (MG), a metal over source/drain (MD), a via over gate (VG), a via over source/drain (VD), etc. in its layout, which may be a full custom layout or semi custom layout. Accordingly, there are a plurality of inter-conductor dielectrics within each standard cell. Here, an inter-conductor dielectric may refer to an inter-metal dielectric (IMD) or inter-layer dielectric (ILD). For ease of description, the term of “inter-conductor dielectric” or “IMD” is used in the following embodiments, and it can imply either IMD, ILD, or both.

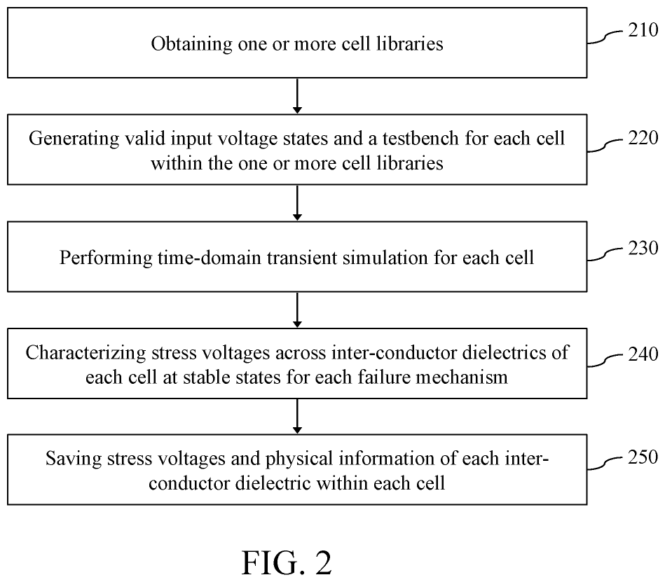

In some embodiments, the TDDB profile database 1045 may be configured to store information about the TDDB profile for each inter-conductor dielectric within each cell. For example, the TDDB profile for each cell may include stress voltages of each inter-conductor dielectric and its physical information (e.g., including parallel-run length or a count of via-to-metal relationships) for each cell. Further details will be described in the following embodiments with respect to FIGS. 2 to 10.

In some embodiments, failures related to inter-metal dielectric (IMD) time-dependent dielectric breakdown (TDDB) within the IC domain may indicate dielectric breakdown occurrences between a via over gate (VG) and a metal over source/drain (MD), between a metal over gate (MG) and a source/drain contact, between a via over source/drain (VD) and metal layer 0 (M0), between metal layer 0 and metal layer 0, between a gate and channel of a MOSFET, among others. However, the present disclosure is not limited thereto. In some embodiments, the chip failure-in-time (FIT) rate of an integrated circuit may be proportional to the total effective count of “via-to-metal” or “metal-to-via” IMDs for via-related failures, while the chip FIT rate may be proportional to the total effective length of metal lines for failures related to metal lines.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC design system 100. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

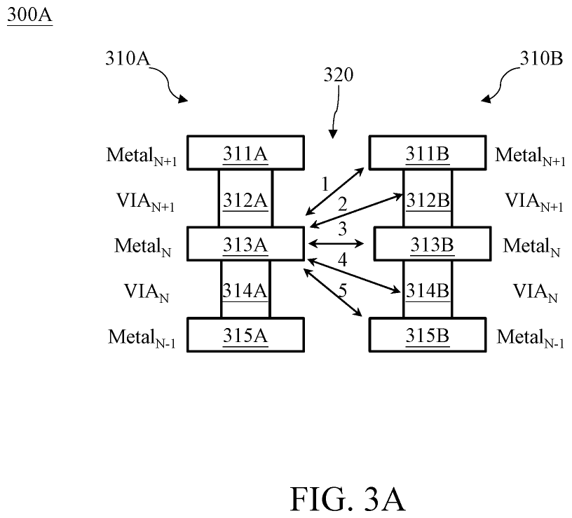

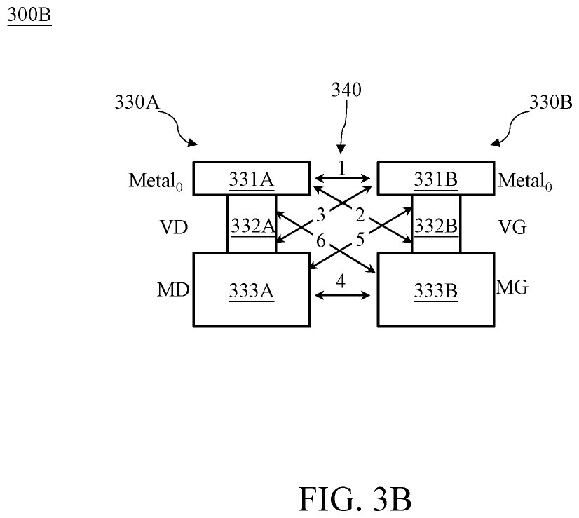

FIG. 2 is a flowchart of a method for developing TDDB profiles of IMD objects for each cell within cell libraries in accordance with some embodiments of the present disclosure. FIG. 3A is a partial cross section of an integrated circuit in accordance with some embodiments of the present disclosure. In some embodiments, the processor 102 may execute the program codes 1041 to perform the process of method 200 shown in FIG. 2.

Operation 210: obtaining one or more cell libraries. In some embodiments, each cell library may store a plurality of cells, intellectual property (IP), and/or circuit blocks that can be used in an automatic placing and routing (APR) process. For example, a cell may refer to a standard cell, an analog cell, a memory cell (e.g., SRAM bit cell), an input/output (I/O) cell, or a circuit block. Additionally, an IP may include one or more cells, while a chip may include one or more cells or IPs.

Operation 220: generating valid input voltage states and a testbench for each cell within the one or more cell libraries. In some embodiments, there may exist one or more valid input voltage states for each cell, and the testbench may include the output state of each cell with respect to the corresponding valid input voltage states. For example, when a cell refers a two-input logic gate, such as AND, OR, NAND, NOR, XOR, etc., the valid input voltage states for a two-input logic gate with input signals A1 and A2 could be (A1, A2)=(0, 0), (0, 1), (1, 0), (1, 1), indicating that all combinations of the input signals A1 and A2 are valid input voltage states. Additionally, for an IP or integrated circuit including a plurality of logic gates, certain combinations of input signals for some logic gates within the IP or IC are unlikely to be input to the respective logic gate during operation of the integrated circuit at stable states, indicating that these combinations of input signals for the logic gates are invalid input voltage states.

Operation 230: performing time-domain transient simulation for each cell. In some embodiments, the time-domain transient simulation for each cell can be executed using the pre-built testbench for each cell, such as applying a respective waveform to the each cell and observing its response over time. Specifically, time-domain transient simulation (also known as time-domain transient analysis), which is a post-layout simulation, involves a set of techniques used to analyze simulation data or experimental results in the time domain, particularly when each cell within the integrated circuit is transitioning between two states.

Operation 240: characterizing stress voltages across inter-conductor dielectrics of each cell at stable states for each failure mechanism (e.g., failures associated with metal lines or via-associated failures). In some embodiments, each stress voltage across an inter-conductor dielectric (e.g., an IMD or ILD) is associated with a polarity for each valid input voltage state, along with physical information about the inter-conductor dielectric. For example, the polarity of each stress voltage may denote the orientation of the stress voltage (e.g., stress direction) across two conductors within each cell for a respective valid input voltage state. Additionally, the physical information about the inter-conductor dielectric may indicate a parallel-run length of the metal lines along the inter-conductor dielectric and/or a valid count of via-to-metal or metal-to-via inter-conductor dielectric.

Operation 250: saving stress voltages and physical information of each inter-conductor dielectric within each cell. In some embodiments, the EDA tool may save the stress voltages and physical information of each inter-conductor dielectric within each cell as a respective TDDB cell profile, indicating that each cell within the cell libraries corresponds to a respective TDDB cell kit file. Additionally, the EDA tool may save the TDDB cell profile of each cell within the cell libraries in the TDDB profile database 1045 shown in FIG. 1.

For ease of description, the conductive layers (e.g., metal layers) are considered in the following example. A plurality of conductive wires (e.g., metal wires) arranged in parallel on each conductive layer of integrated circuit 300A in FIG. 3A, which is a partial cross section of the integrated circuit 300A. As depicted in FIG. 3A, the integrated circuit 300A includes two adjacent semiconductor structures 310A and 310B, each including a plurality of conductive layers (e.g., metal layers 0 to 15) disposed over a substrate (not shown). For brevity, the inter-metal dielectric objects with reference to metal layer N (e.g., Metal_{N}, where 1≤N<15), its neighboring metal layers N+1 and N−1 (e.g., Metal_{N+1} and Metal_{N-1}), and vias therebetween (e.g., VIA_{N+1} and VIA_{N}) within the semiconductor structure 310A are illustrated in FIG. 3A. It should be noted that dielectric 320 exists between the semiconductor structures 310A and 310B, and it can be regarded as an inter-metal dielectric between the metal layers N−1 to N+1 within the semiconductor structure 310A and 310B. It should be noted that the components within the semiconductor structure 310A are electrically connected, while the components within the semiconductor structure 310B are also electrically connected.

Referring to FIG. 3A, for a given conductive wire on a particular conductive layer (e.g., Metal_{N} or N-th metal layer), the EDA tool (e.g., the processor 102) may compute the stress voltage between the metal wire 313A and its IMD components within the semiconductor structure 310B. Specifically, the IMD components of the metal wire 313A on the N-th metal layer Metal_{N} within the semiconductor 310A may include at least an adjacent metal wire 313B on the N-th metal layer Metal_{N}, a first metal wire 311B on the (N+1)-th metal layer Metal_{N}+1 above the adjacent metal wire 313B, a second metal wire 315B on the (N−1)-th metal layer Metal_{N}−1 below the adjacent metal wire 313B, a via 312B on (N+1)-th via layer VIA_{N+1} connected between the adjacent metal wire 313B and the first metal wire 311B, and a via 314B on (N−1)-th via layer VIA_{N-1} connected between the adjacent metal wire 313B and the second metal wire 315B within the semiconductor structure 310B. Accordingly, the metal wire 313A on the N-th metal layer Metal_{N} within the semiconductor structure 310A has 5 IMD components, which are show as 5 double arrows indexed from 1 to 5 in FIG. 3A, as illustrated in Table 1 as follows.

TABLE 1

| Index | IMD object to be processed |
|---|---|
| 1 | Metal_{N}-Metal_{N+1} IMD |
| 2 | Metal_{N}-VIA_{N+1} IMD |
| 3 | Metal_{N}-Metal_{N} IMD |
| 4 | Metal_{N}-VIA_{N} IMD |
| 5 | Metal_{N}-Metal_{N-1} IMD |

For example, the IMD object 1 refers to the IMD object between the metal wire 313A on N-th metal layer Metal_{N} within the semiconductor structure 310A and the metal wire 311B on (N+1)-th metal layer Metal_{N}+1 within the semiconductor structure 310B; the IMD object 2 refers to the IMD object between the metal wire 313A on N-th metal layer Metal_{N} within the semiconductor structure 310A and the via 312B on (N+1)-th via layer VIA_{N+1} within the semiconductor structure 310B; the IMD object 3 refers to the IMD object between the metal wire 313A on N-th metal layer Metal_{N} within the semiconductor structure 310A and the metal wire 313B on N-th metal layer Metal within the semiconductor structure 310B; the IMD object 4 refers to the IMD object between the metal wire 313A on N-th metal layer Metal_{N} within the semiconductor structure 310A and the via 314B on N-th via layer VIA_{N} within the semiconductor structure 310B; and the IMD object 5 refers to the IMD object between the metal wire 313A on N-th metal layer Metal_{N} within the semiconductor structure 310A and the metal wire 315B on (N−1)-th metal layer Metal_{N}−1 within the semiconductor structure 310B.

FIG. 3B is a partial cross section of an integrated circuit in accordance with still some embodiments of the present disclosure.

In some embodiments, the IMD objects associated with a metal wire on metal layer 0 (Metal₀) and its lower components or layers, such as via over gate (VG), via over source/drain (VD), metal over source/drain (MD), and metal over gate (MG), are shown in FIG. 3B, which illustrates a partial cross section of an integrated circuit 300B including semiconductor structures 330A and 330B. For example, the semiconductor structure 330A includes a metal wire 331A on metal layer 0 (Metal₀), VD 332A, and MD 333A arranged in a stacked manner, while the semiconductor 330B includes another metal wire 331B on metal layer 0 (Metal₀), VG 332B, and MG 333B arranged in a stacked manner. It should be noted that the components within the semiconductor structure 330A are electrically connected, while the components within the semiconductor structure 330B are also electrically connected.

In some embodiments, the EDA tool (e.g., the processor 102) may further compute the stress voltage between the IMD components within the semiconductor structures 330A and 330B. Specifically, the IMD components of the metal wire 331A on metal layer 0 (e.g., Metal₀) within the semiconductor structure 330A may include the metal wire 331B on metal layer 0 (e.g., Metal₀), and VG 332B below the metal wire 331B within the semiconductor structure 330B. Additionally, the IMD components of VD 332A within the semiconductor structure 330A may include the metal wire 331B on metal layer 0 (e.g., Metal₀) and the MG 333B within the semiconductor structure 330B. Furthermore, the IMD components of MD 333A within the semiconductor structure 330A may include VG 332B and MG 333B within the semiconductor structure 330B.

Accordingly, six IMD components exist between the components within the semiconductor structures 330A and 330B, which are show as 6 double arrows indexed from 1 to 6 in FIG. 3B, as illustrated in Table 2 as follows.

TABLE 2

| Index | IMD object to be processed |
|---|---|
| 1 | Metal₀-Metal₀ IMD |
| 2 | Metal₀-VG IMD |
| 3 | Metal₀-VD IMD |
| 4 | MG-MD IMD |
| 5 | VG-MD IMD |
| 6 | VD-MG IMD |

For example, the IMD object 1 pertains to the IMD object between the metal wires 331A and 331B on metal layer 0 (e.g., Metal₀) within the semiconductor structures 330A and 330B. The IMD object 2 pertains to the IMD object between the metal wire 331A on metal layer 0 (e.g., Metal₀) within the semiconductor structure 330A and the VG 332B within the semiconductor structure 330B. The IMD object 3 pertains to the IMD object between VD 332A within the semiconductor structure 330A and the metal wire 331B metal layer 0 (e.g., Metal₀) within the semiconductor structure 330B. The IMD object 4 pertains to the IMD object between MD 333A within the semiconductor structure 330A and MG 333B within the semiconductor structure 330B. The IMD object 5 pertains to the IMD object between the MD 333A within the semiconductor structure 310A and VG 332B within the semiconductor structure 330B. The IMD object 6 pertains to the IMD object between VD 332A within the semiconductor structure 330A and MG 333B within the semiconductor structure 330B.

It should be noted that the EDA tool computes the IMD object between a component on a specific layer within the semiconductor structure 330A and another component on the specific layer or an adjacent layer within the semiconductor structure 330B. However, the EDA tool does not consider the via-to-via IMD objects between the semiconductor structures 330A and 330B. For example, when considering the metal wire 331A on metal layer 0 (e.g., Metal₀) within the semiconductor structure 330A, the metal wire 331B is an associated component on metal layer 0, and VG 332B is another associated component on a layer adjacent to metal layer 0 within the semiconductor structure 330B. Accordingly, the EDA tool may consider the IMD objects 1 and 2, as shown in Table 2, as being associated with the metal wire 331A within the semiconductor structure 330A. Similarly, when considering the VD 332A on VD layer within the semiconductor structure 330A, the metal wire 331B, which is on metal layer 0 adjacent to VG layer with substantially equal elevation as VD layer with respect to the substrate (not shown), is an associated component. Additionally, MG 333B, which is on MG layer adjacent to VG layer, is also an associated component. However, the EDA tool does not consider the IMD object between VD 332A and VG 332B since they are on layers with substantially equal elevation with respect to the substrate (not shown). The components associated with MD 333A can be calculated in a similar manner, specifically VG 332B and MG 333B within the semiconductor structure 330B.

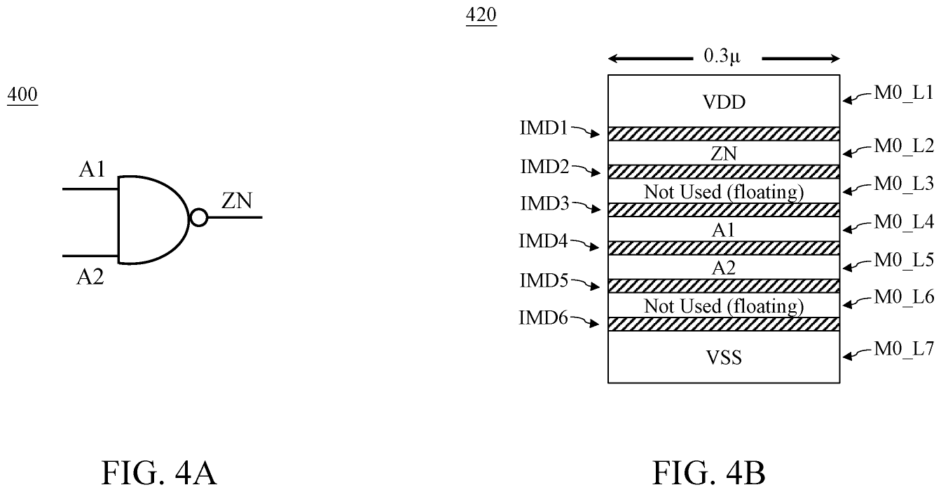

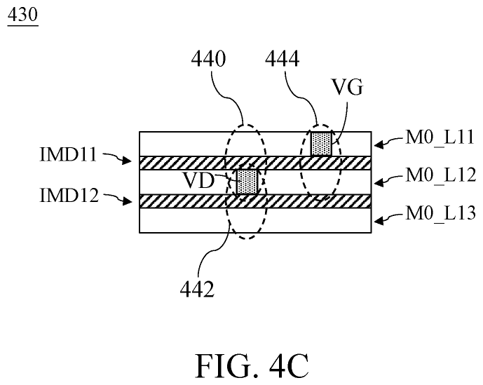

FIG. 4A is a diagram of a two-input NAND gate in accordance with some embodiments of the present disclosure. FIG. 4B is a top layout view of metal layer 0 of the two-input NAND gate in FIG. 4A.

In some embodiments, a schematic diagram of a two-input NAND gate 400 (e.g., an NAND2 cell) and its top layout view of metal layer 0 are illustrated in FIG. 4A and FIG. 4B, respectively. For example, the NAND gate 400 receives two input signals A1 and A2, and generate an output signal ZN. For brevity, the M0-to-M0 IMDs of the NAND gate 400 are considered. Referring to FIG. 4B, a plurality of metal wires, designated as M0_L1 to M0_L7 are arranged on metal layer 0 within the layout of the NAND gate 400, and a plurality of IMD objects, labeled IMD1 to IMD6, are positioned between each pair of two adjacent metal lines M0 L1 to M0_L7. It should be noted that the layout of the NAND gate 400 is not limited to the top layout view shown in FIG. 4B, and it may include more metal layers and metal wires thereon.

For example, the metal wires M0_L1 and M0_L7 are supplied with a power supply voltage VDD and a reference voltage VSS, respectively. The metal wires M0_L4 and M0 L5 receives the input signals A1 and A2, respectively, while the metal wire M0_L2 carries the output signal ZN of the NAND gate 400. It should be noted that the metal wire M0 L3 and M0_L6 are not used, and are thus floating.

The valid input/output voltage states in logic format are shown in Table 3 as follows.

TABLE 3

| A1 | A2 | ZN |
|---|---|---|
| 0 | 0 | 1 |
| 0 | 1 | 1 |
| 1 | 0 | 1 |
| 1 | 1 | 0 |

For example, “1” represents the power supply voltage VDD, such as 0.8V, and “0” represents the reference voltage VSS, such as 0V. Additionally, the valid input/output states shown in Table 3 indicates that the input/output logic states are sampled when the output signal ZN becomes stable in the time domain. An example of invalid input/output voltage states may be (A1, A2, ZN)=(1, 1, 1), indicating that the combination of input/output signals are unlikely to occur at stable states of the NAND gate 400. Since the metal wires M0_L3 and M0_L6 are not used, their neighboring IMDs, such as IMD2, IMD3, IMD5, and IMD6, do not suffer from stress voltages across the IMDs (i.e., no dual-side stress) due to the coupling effect. Specifically, the IMD object IMD1 between metal wires M0_L1 and M0_L2 and the IMD objects IMD4 between metal wires M0_L4 and M0_M5 could suffer from stress voltages across them, and the EDA tool can identify the IMD objects IMD1 and IMD4 (e.g., also identified as M0-M0_1 and M0-M0_2, respectively) from each metal layer of the layout of the NAND gate 400 to characterize the stress voltage thereon with its polarity for each valid voltage state, along with the corresponding physical information.

In the first valid input/output voltage state of the NAND gate 400, where (A1, A2, ZN)=(0, 0, 1), both metal wires M0_L4 (representing signal A1) and M0_L5 (representing signal A2) are supplied with the reference voltage VSS (e.g., 0V), and the metal wire M0_L2 carries the output signal ZN, which is at the power supply voltage VDD. At this time, the metal wires M0_L1 and M0_L2 positioned on opposite sides of the IMD object IMD1 (e.g., M0-M0_2) are both at the power supply voltage VDD, resulting in the IMD object IMD1 (e.g., M0-M0_2) not sensing any stress voltage, with its polarity being 0, indicating an absence of stress. Additionally, the metal wires M0_L4 and M0_L5 positioned on opposite sides of the IMD object IMD4 (e.g., M0-M0_1) are both at the reference voltage VSS, resulting in the IMD object IMD4 (e.g., M0-M0_1) not sensing any stress voltage (e.g., V(A1)=V(A2)), with its polarity being 0, indicating the absence of stress.

In the second valid input/output voltage states of the NAND gate 400, where (A1, A2, ZN)=(0, 1, 1), the metal wires M0_L4 (representing signal A1) and M0_L5 (representing signal A2) are supplied with the reference voltage VSS (e.g., 0V) and the power supply voltage VDD (e.g., 0.8V), respectively, while the metal wire M0_L2 carries the output signal ZN, which is at the power supply voltage VDD. At this time, the metal wires M0_L1 and M0_L2 positioned on opposite sides of the IMD object IMD1 (e.g., M0-M0_2) are at the power supply voltage VDD, resulting in the IMD object IMD1 (e.g., M0-M0_2) not sensing any stress voltage, with its polarity being 0, indicating an absence of stress. Additionally, the metal wires M0_L4 and M0_L5 positioned on opposite sides of the IMD object IMD4 (e.g., M0-M0_1) are at the reference voltage VSS and the power supply voltage VDD, respectively, resulting in the IMD object IMD4 (e.g., M0-M0_1) sensing a stress voltage (e.g., V(A1)−V(A2)=−VDD), with its polarity being −1, indicating the orientation of the stress voltage is from metal wire M0_L5 to metal wire M0_L4.

In the third valid input/output voltage states of the NAND gate 400, where (A1, A2, ZN)=(1, 0, 1), the metal wires M0_L4 (representing signal A1) and M0_L5 (representing signal A2) are supplied with the power supply voltage VDD (e.g., 0.8V) and the reference voltage VSS (e.g., 0V), respectively, while the metal wire M0_L2 carries the output signal ZN, which is at the power supply voltage VDD. At this time, the metal wires M0 L1 and M0 L2 positioned on opposite sides of the IMD object IMD1 (e.g., M0-M0_2) are at the power supply voltage VDD, resulting in the IMD object IMD1 (e.g., M0-M0_2) not sensing any stress voltage, with its polarity being 0, indicating an absence of stress. Additionally, the metal wires M0_L4 and M0_L5 positioned on opposite sides of the IMD object IMD4 (e.g., M0-M0_1) are at the power supply voltage VDD and the reference voltage VSS, respectively, resulting in the IMD object IMD4 (e.g., M0-M0_1) sensing a stress voltage (e.g., V(A1)−V(A2)−VDD), with its polarity being 1, indicating the orientation of the stress voltage is from metal wire M0_L4 to metal wire M0_L5.

In the fourth valid input/output voltage state of the NAND gate 400, where (A1, A2, ZN)=(1, 1, 0), both metal wires M0_L4 (representing signal A1) and M0_L5 (representing signal A2) are supplied with the power supply voltage (e.g., 0.8V), and the metal wire M0_L2 carries the output signal ZN, which is at the reference voltage VSS. At this time, the metal wires M0_L1 and M0_L2 positioned on opposite sides of the IMD object IMD1 (e.g., M0-M0_2) are at the power supply voltage VDD and the reference voltage VSS, respectively, resulting in the IMD object IMD1 (e.g., M0-M0_2) sensing a stress voltage, with its polarity being 1, indicating the orientation of the stress voltage is from metal wire M0_L1 to metal wire M0_L2. Additionally, the metal wires M0_L4 and M0_L5 positioned on opposite sides of the IMD object IMD4 (e.g., M0-M0_1) are both at the power supply voltage VDD, resulting in the IMD object IMD4 (e.g., M0-M0_1) not sensing any stress voltage (e.g., V(A1)=V(A2)), with its polarity being 0, indicating the absence of stress.

Accordingly, upon completion of analyzing the stress voltage of each IMD object within the NAND gate 400 (e.g., NAND cell) for each valid input/output voltage state, the EDA tool (e.g., processor 102) could built a TDDB cell profile (or TDDB cell kit) for the NAND gate 400 as shown in Table 4.

TABLE 4

| | |
|---|---|
| File | NAND2's TDDB cell profile |

| | |
|---|---|
| Content | NAND2 start |

| | | | | |
|---|---|---|---|---|
| A1 | A2 | ZN | M0-M0_1 | M0-M0_2 |
| 0 | 0 | 1 | 0 | 0 |
| 0 | 1 | 1 | −1 | 0 |
| 1 | 0 | 1 | 1 | 0 |
| 1 | 1 | 0 | 0 | 1 |
| X | X | X | 0.3μ | 0.3μ |

NAND2 end

For example, the TDDB cell profile for the NAND gate 400 (e.g., NAND2 cell) records all valid input/output voltage states (A1, A2, ZN) and the stress direction (or orientation) of the stress across the IMD objects M0-M0_1 (e.g., IMD4) and M0-M0_2 (e.g., IMD1). Additionally, the values 0.3μ (e.g., in units of meters) at the columns of IMD objects M0-M0_1 and M0-M0_2, corresponding to the combination (A1, A2, ZN)=(X, X, X) (i.e., “X” denotes “don't care”), may refer to the physical information, such as the drawing parallel-run length, of the respective IMD objects. For example, the layout 420 of metal layer 0 is rectangular-shaped with a horizontal dimension of 0.3 μm (e.g., a drawn physical length on the layout 420), as shown in FIG. 4B. Regarding the IMD object IMD4 (e.g., M0-M0_1), the metal wires M0 L4 and M0_L5 are parallel along the IMD object IMD4 for a length of 0.3 μm, indicating that the drawing parallel-run length of the IMD object IMD4 is 0.3 μm. Similarly, regarding the IMD object IMD1 (e.g., M0-M0_2), the metal wires M0_L1 and M0_L2 are parallel along the IMD object IMD1 for a length of 0.3 μm, indicating that the drawing parallel-run length of the IMD object IMD1 is also 0.3 μm. In some embodiments, the TDDB cell profiles (or TDDB cell kits) for the remaining cells within the cell libraries can be built by the EDA tool in a similar manner.

FIG. 4C is another top layout view of metal layer 0 of the two-input NAND gate in FIG. 4A.

In some embodiments, the values at the columns of IMD objects M0-M0_1 and M0-M0_2, corresponding to the combination (A1, A2, ZN)=(X, X, X), may refer to the physical information, such as the total count of via-to-metal (or metal-to-via) IMDs, of the respective IMD objects. For example, double arrows indexed 2 and 4 shown in FIG. 3A may denote metal-to-via (or via-to-metal) IMDs, while double arrows indexed 2, 3, 5, and 6 shown in FIG. 3B may denote metal-to-via (or via-to-metal) IMDs.

Referring to FIG. 4C, the layout 430 presents a top view of metal layer 0 of the NAND gate 400, including three parallel metal wires designated as M0_L11, M0_L12, and M0_L13 positioned on metal layer 0. Additionally, the metal wires M0_L11 and M0_L12 are positioned on opposite sides of the IMD object IMD11, while the metal wires M0 L12 and M0 L13 are positioned on opposite sides of the IMD object IMD12. Furthermore, a via over source/drain (VD) is positioned on the metal wire M0_L12, and a via over gate (VG) is positioned on the metal wire M0_L11. In some embodiments, the count of via-to-metal relationship with respect to VD includes a first portion and a second portion. It should be noted that the VD and metal layer 0 are not on the same layer. The first portion has a count of 0.5 for the VD to M0 L11 relationship in region 440, while the second portion has another count of 0.5 for the VD to M0_L13 relationship in region 442. Accordingly, the total count for VD is 1. Additionally, the count of via-to-metal relationship with respect to VG is 0.5 due to the one-sided via-to-metal relationship for VG within region 444. Accordingly, the EDA tool (e.g., processor 102) could compute the total count of the via-to-metal (or metal-to-via) IMDs within each cell of the cell libraries in a manner similar to that described above.

It should be noted that the drawing parallel-run length and total count of via-to-metal relationships for an IMD object can be converted to an effective parallel-run length and an effective total count of via-to-metal relationships for the IMD object, the details of which will be described later.

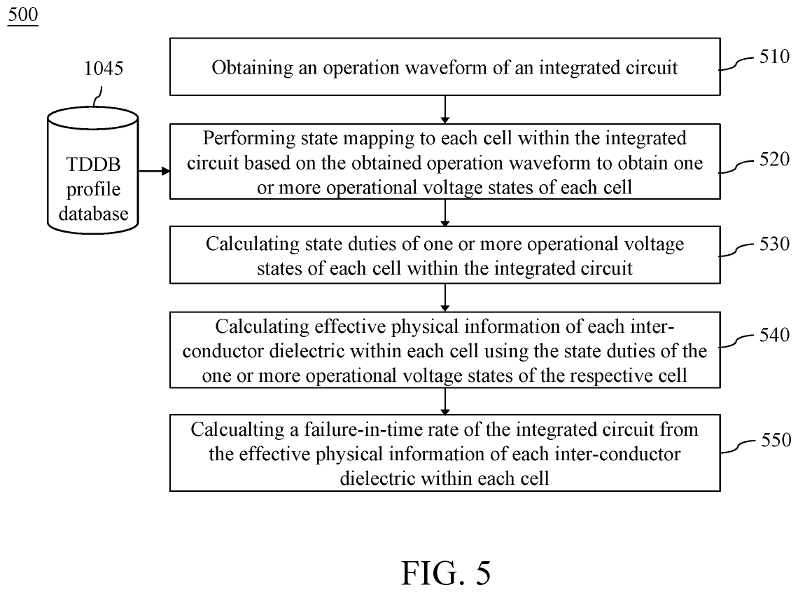

FIG. 5 is a flowchart of a method for calculating a failure-in-time (FIT) rate of an integrated circuit under a specific operation mode in accordance with some embodiments of the present disclosure. Please refer to both FIG. 1 and FIG. 5. The method 500 includes operations 510 to 550.

In some embodiments, the integrated circuit may have a plurality of operation modes, such as a medium load mode, a high activity mode, a custom mode, a sleep mode, etc. For simplicity, a single operation mode, such as the medium load mode, is used by the integrated circuit. Specifically, each of the operation modes may correspond to a respective operation waveform, and the voltage states or logic states of input signals and output signals of the integrated circuit may vary over time. Accordingly, the combination of voltage states of the input signals and output signals at each sample time can be regarded as a specific operation vector.

Operation 510: obtaining operation waveforms of an integrated circuit. In some embodiments, the integrated circuit, which may be a central processing unit, a graphics processing unit, a digital signal processor, an application-specific integrated circuit, etc., may include a plurality of cells selected from the cell libraries, and each cell has its respective TDDB cell profile stored in the TDDB profile database 1045. For purposes of description, it is assumed that the integrated circuit has N cells and Z IMDs, where Z and N are positive integers and Z>N, indicating that the index n of cells ranges from 1 to N, and the index z of IMDs ranges from 1 to Z. Additionally, the integrated circuit has M operation modes and K voltage states, where M and K are positive integers, indicating that the index m of operation modes ranges from 1 to M, and the index k ranges from 1 to K (e.g., K is a cell-dependent variable). For simplicity, 1 failure mechanism, which is associated to metal lines, is used in the embodiments of FIGS. 5 to 7.

Operation 520: performing state mapping to each cell within the integrated circuit based on the obtained operation waveform to obtain one or more operational voltage states of each cell. In some embodiments, the EDA tool (e.g., processor 102) may obtain the TDDB cell profiles of all cells within the cell libraries, thereby performing state mapping to each cell based on the obtained operation waveforms of the integrated circuit. For example, the TDDB cell profile for each cell may record all valid input/output voltage states and corresponding physical information. However, each cell within the integrated circuit may receive a respective internal operation waveform based on the operation waveform of the integrated circuit. Accordingly, the EDA tool can perform the state mapping process to map the valid voltage states of each cell to the operational voltage states (e.g., could be all or a subset of the valid voltage states) of each cell within the integrated circuit.

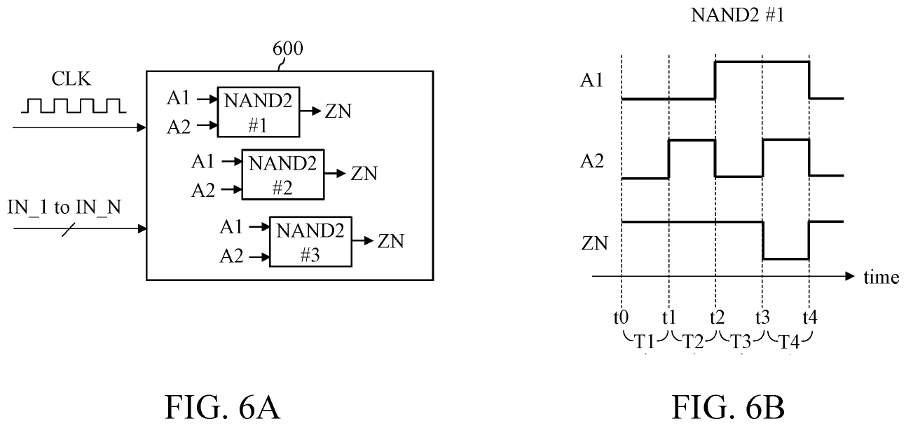

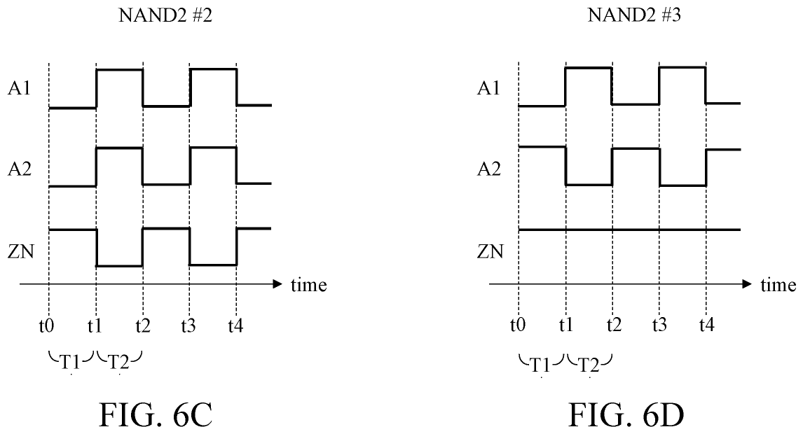

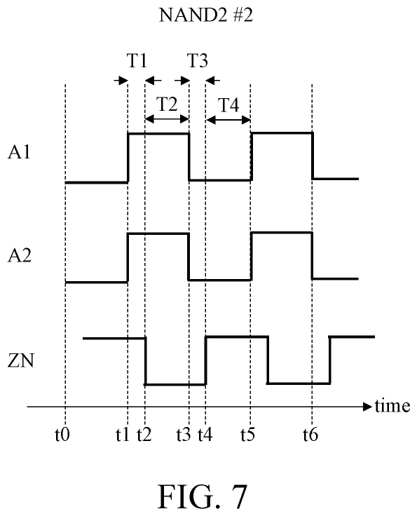

Operation 530: calculating state duties of the one or more operational voltage states of each cell within the integrated circuit. In some embodiments, an operational voltage state may denote a voltage state with a state duty exceeding 0%, whereas a non-operational voltage state may indicate a voltage state with a state duty of 0%. For example, upon determination of the operational voltage states of each cell within the integrated circuit, the percentage of a duty period of a particular operation voltage state relative to the overall duty period of all operational voltage states can be defined as the state duty of the particular operational voltage state. Further details regarding the state mapping process and the determination of the state duty of each operational voltage state of each cell will be elaborated in the embodiments of FIGS. 6A to 6D and FIG. 7.

Operation 540: calculating effective physical information of each inter-conductor dielectric within each cell using the state duties of the one or more operational voltage states of each cell. In some embodiments, the effective physical information may refer to the effective parallel-run length of metal wires along each inter-conductor dielectric when the failure mechanism is associated with metal lines. Alternatively or additionally, the effective physical information may refer to the effective total count of via-to-metal (or metal-to-via) inter-conductor dielectrics when the failure mechanism is via-related.

Operation 550: calculating a failure-in-time rate of the integrated circuit from the effective physical information of each inter-conductor dielectric within the integrated circuit. In some embodiments, the EDA tool may compute the summation of the effective physical information of each inter-conductor dielectric within the integrated circuit, and calculate the FIT rate from the summation of effective physical information using equation (1) as follows.

$$( 1 )$$

$$lifetime = {τ}_{o} \times exp ( - γ \sqrt{E} ) \times {( L )}^{- \frac{1}{{β}_{a r e a}}} \times exp ( \frac{{E}_{a}}{k T} ) \times exp ( \frac{1}{β} * ln ( - ln ( 1 - F ) ) )$$

In equation (1), the term “lifetime” refers to an expected operation time of a cell, IP or integrated circuit, e.g., 10 years or 87,600 hours. “E” denotes the electrical field based on the voltage stress and separation distance between the adjacent conductor features (e.g., adjacent metal wires or vias); “L” denotes the effective physical information, which could be an effective count of via-to-metal IMDs, or effective parallel-run length in cases in which adjacent conductor features are coextensive; k denotes the Boltzmann's constant; T denotes the absolute operation temperature; τₒ, γ, βₐᵣₑₐ, Eₐ, and β are technology dependent coefficients obtained from one or both of measurement data or a model forecast; and F denotes the number of failures during the lifetime under a specific failure mechanism (e.g., failures associated with metal lines or via-associated failures). In some embodiments, F can be converted to failure-in-time (FIT) rate by dividing F by (lifetime*1e9), where the units of lifetime and 1e9 are both hours. The FIT rate of a semiconductor device implies the expected number of failures in one billion (1e9) device-hours of operation.

In some embodiments, by inputting one or more voltage stress-derived electric field values and one or more temperatures, along with the other input parameters into a lifetime equation, e.g., equation (1), a FIT rate as function of F can be calculated based on a simulation of actual operating conditions.

FIG. 6A is a diagram of three NAND gates within an integrated circuit in accordance with some embodiments of the present disclosure. FIGS. 6B to 6D are waveform diagrams of internal operation waveforms of the respective NAND gates in FIG. 6A.

In some embodiments, the integrated circuit 600 includes three two-input NAND gates, designated as NAND2 #1, NAND2 #2, and NAND2 #3, as depicted in FIG. 6A. It should be noted that the three NAND gates are for purposes of description and brevity, and the integrated circuit 600 may include additional cells or circuits. For example, each of the NAND gates may receive two input signals A1 and A2 and generate an output signal ZN. Additionally, the integrated circuit 600 may receive a clock signal CLK and a plurality of input signals IN_1 to IN N which can be collectively referred to as an operation waveform of the integrated circuit 600.

Moreover, each NAND gate #1 to #3 has a respective operation waveform, which is an internal operation waveform derived from the operation waveform of the integrated circuit 600, as depicted in FIGS. 6B, 6C, and 6D, respectively. Furthermore, the TDDB cell profile for each NAND gate #1 to #3 is similar to that shown in Table 4.

Referring to FIG. 6B, which illustrates the operation waveform of the NAND gate #1, the valid input/output voltage states of the NAND gate #1 includes four combinations (A1, A2, ZN)=(0, 0, 1), (0, 1, 1), (1, 0, 1), and (1, 1, 0) (i.e., states 1 to 4), where four combinations of input signals (A1, A2)=(0, 0), (0, 1), (1, 0), and (1, 1) are repeated periodically. These combinations can be obtained at times t0, t1, t2, and t3, respectively. It should be noted that the time intervals T1 to T4 for the respective combinations (A1, A2, ZN)=(0, 0, 1), (0, 1, 1), (1, 0, 1), and (1, 1, 0) are equal, indicating that each valid input/output voltage state maintains a state duty of 25%. Accordingly, when the EDA tool performs state mapping of the NAND gate #1, the EDA tool may obtain the TDDB cell profile of the NAND2 cell from the TDDB profile database 1045, thereby building the state mapping table of the NAND gate #1 as shown in Table 5.

TABLE 5

| A1 | A2 | ZN | State Duty |
|---|---|---|---|
| 0 | 0 | 1 | 25% |
| 0 | 1 | 1 | 25% |
| 1 | 0 | 1 | 25% |
| 1 | 1 | 0 | 25% |

Accordingly, by mapping the operation waveform of the NAND gate #1 to its voltage states recorded in the TDDB cell profile, the four state duties of the NAND gate #1 can be derived as 25%, 25%, 25%, and 25% for the voltage state combinations (A1, A2, ZN)=(0, 0, 1), (0, 1, 1), (1, 0, 1), and (1, 1, 0), respectively.

Referring to FIG. 6C, which illustrates the operation waveform of the NAND gate #2, the valid input/output voltage states of the NAND gate #2 includes two combinations (A1, A2, ZN)=(0, 0, 1) and (1, 1, 0), where two combinations of input signals (A1, A2)=(0, 0) and (1, 1) are repeated periodically. These two combinations can be obtained at times to and t1, respectively. It should be noted that the time intervals T1 to T2 for the respective combinations (A1, A2, ZN)=(0, 0, 1) and (1, 1, 0) are equal, indicating that each valid input/output voltage state has a state duty of 50%. Additionally, the state duties for the remaining two combinations (A1, A2, ZN)=(0, 1, 1) and (1, 0, 1) are both 0%. Accordingly, when the EDA tool performs state mapping of the NAND gate #2, the EDA tool may obtain the TDDB cell profile of the NAND2 cell from the TDDB profile database 1045, thereby building the state mapping table of the NAND gate #2 as shown in Table 6.

TABLE 6

| A1 | A2 | ZN | State Duty |
|---|---|---|---|
| 0 | 0 | 1 | 50% |
| 0 | 1 | 1 | 0% |
| 1 | 0 | 1 | 0% |
| 1 | 1 | 0 | 50% |

Accordingly, by mapping the operation waveform of the NAND gate #2 to its voltage states recorded in the TDDB cell profile, the four state duties of the NAND gate #2 can be derived as 50%, 0%, 0%, and 50% for the voltage state combinations (A1, A2, ZN)=(0, 0, 1), (0, 1, 1), (1, 0, 1), and (1, 1, 0), respectively.

Referring to FIG. 6D, which illustrates the operation waveform of the NAND gate #3, the valid input/output voltage states of the NAND gate #2 includes two combinations (A1, A2, ZN)=(0, 1, 1) and (1, 0, 1), where two combinations of input signals (A1, A2)=(0, 1) and (1, 0) are repeated periodically. These two combinations can be obtained at times t0 and t1, respectively. It should be noted that the time intervals T1 to T2 for the respective combinations (A1, A2, ZN)=(0, 1, 1) and (1, 0, 1) are equal, indicating that each valid input/output voltage state has a state duty of 50%. Additionally, the state duties for the remaining two combinations (A1, A2, ZN)=(0, 0, 1) and (1, 1, 0) are both 0%. Accordingly, when the EDA tool performs state mapping of the NAND gate #3, the EDA tool may obtain the TDDB cell profile of the NAND2 cell from the TDDB profile database 1045, thereby building the state mapping table of the NAND gate #3 as shown in Table 7.

TABLE 7

| A1 | A2 | ZN | State Duty |
|---|---|---|---|
| 0 | 0 | 1 | 0% |
| 0 | 1 | 1 | 50% |
| 1 | 0 | 1 | 50% |
| 1 | 1 | 0 | 0% |

Accordingly, by mapping the operation waveform of the NAND gate #3 to its voltage states recorded in the TDDB cell profile, the four state duties of the NAND gate #3 can be derived as 0%, 50%, 50%, and 0% for the voltage state combinations (A1, A2, ZN)=(0, 0, 1), (0, 1, 1), (1, 0, 1), and (1, 1, 0), respectively.

Attention now is directed back to FIG. 5. In some embodiments, when performing operation 540, the EDA tool may use the state mapping table (e.g., Tables 5 to 7) of each NAND gate #1 to #3 to calculate an effective parallel-run length of each IMD within each NAND gate #1 to #3 using the state duties of the operational voltage states thereof. For example, the voltage stress across an IMD can be classified as a DC (direct-current) voltage stress and an AC (alternating-current) voltage stress. An IMD with an AC voltage stress has recovering effect, which results in either a longer lifetime at the same failure rate or a smaller failure rate at the same lifetime. Referring to FIG. 4B, when the power supply voltage VDD=0.8V and the output signal ZN is fixed at the reference voltage (e.g., 0V), it indicates that the metal wires M0_L1 and M0_L2 convey the power supply voltage VDD and the reference voltage VSS, representing that the DC voltage stress across the IMD object IMD1 is also fixed at 0.8V. Accordingly, the effective parallel-run length of the IMD object IMD1 is equal to the drawing parallel-run length, which is 0.3 μm.

It should be noted that a specific metal wire on metal layer 0 could be partitioned into two or more segments. One of the segments may convey an input signal (e.g., A1 or A2) or an output signal (e.g., ZN), resulting in the length of parallel metal wires positioned on opposite side of a specific IMD object not equaling to the drawn physical length in the layout of the NAND gate 400. In such situation, the effective parallel-run length of the specific IMD object is shorter than the drawing physical length in the layout of the NAND gate 400.

In some embodiments, referring to FIG. 4B, when the operation waveform of the NAND gate 400 is similar to the waveform diagram shown in FIG. 6C, there are two operational input/output voltage states, corresponding to combinations (A1, A2, ZN)=(0, 0, 1) and (1, 1, 0), each with a state duty of 50%. Thus, the voltage on the metal wire M0_L2 conveying the output signal ZN may by an AC voltage following the variations of input signals A1 and A2. For purposes of description, the power supply voltage VDD=0.8V and the reference voltage VSS=0V. When the voltage state (A1, A2, ZN)=(0, 0, 1) (i.e., state 1), the voltage stress across the IMD object IMD1 is 0.8V, resulting in the effective parallel-run length Lpr₁ of the IMD object IMD1 for state 1 being equal to the drawing parallel-run length, which is 0.3 μm. When the voltage state (A1, A2, ZN)=(1, 1, 0) (i.e., state 4), the voltage stress across the IMD object IMD1 is 0V, resulting in the effective parallel-run length Lpr₄ of the IMD object IMD1 for state 4 being equal to Oum due to the absence of stress. Accordingly, the EDA tool can calculate the effective parallel-run length Lpr of the IMD object IMD1 using equation (2) as follows.

Effective Lpr=Σₖ(LPrₖ·Alphaₖ) (2)

In equation (2), k represents the index number of state; Alphaₖ denotes the scaling factor of the parallel-run length for the AC effect, and Alphaₖ<1. Accordingly, the effective parallel-run length of the IMD object IMD1 can be calculated as 0.3 μm*Alpha₁ since valid voltage stress (e.g., 0.8V) across the IMD object IMD1 is found in state 1.

In some embodiments, the proportional relationship between lifetime and L (or Lpr) in equation (1) can be expressed using equation (3) as follows.

$$lifetime ∝ ( L ) \frac{1}{{β}_{a r e a}} \qquad ( 3 )$$

Additionally, in the aforementioned example of AC voltage stress, a valid voltage stress across the IMD object IMD1 is found in state 1, which maintains a state duty “duty1” of lifetime, and duty1 equals to 50%. Furthermore, the relationship between the lifetime scaling factor S_{AC} due to the AC voltage stress and the scaling factor Alphaₖ of the parallel-run length L (or Lpr) can be expressed using equation (4) as follows.

$$lifetime \times \frac{1}{{duty}_{k}} \times {S}_{A C} ∝ {( L \times {Alpha}_{k} )}^{- \frac{1}{{β}_{a r e a}}} \qquad ( 4 )$$

In equation (4), dutyₖ denotes the state duty for state k. Based on equations (3) and (4), the scaling factor Alphaₖ of the parallel-run length Lpr can be expressed using equation (5) as follows.

$${Alpha}_{k} = {( \frac{{S}_{A C}}{{duty}_{k}} )}^{- \frac{1}{{β}_{a r e a}}} \qquad ( 5 )$$

In equation (5), both S_{AC} and βₐᵣₑₐ are technology-dependent coefficients. Additionally, when S_{AC}>1 and Alphaₖ<1, it implies that the lifetime of the IMD object IMD1 is relaxed by the AC effect.

FIG. 7 is a waveform diagram of an internal operational waveform of the NAND gate #2 with propagation delay in accordance with the embodiment of FIG. 6A.

In some embodiments, when considering the propagation delay between the input signals A1 and A2 and the output signal ZN of the NAND gate #2 in FIG. 6A, the internal waveform of the NAND gate #2 is shown in FIG. 7. Specifically, compared to the valid input/output voltage states recorded in the TDDB cell profile of the NAND2 cell, two additional states, corresponding to the combinations (A1, A2, ZN)=(1, 1, 1) and (0, 0, 0), appear due to the propagation delay of the NAND gate #2. For example, the NAND gate #2 receives input signals (A1, A2)=(1, 1) at time t1, and generates the output signal ZN=0 at time t2. Time interval T1 between times t1 and t2 can be referred to as the propagation delay of the NAND gate #2. Accordingly, during time interval T1, the input/output voltage state (A1, A2, ZN) is (1, 1, 1), which is beyond the valid input/output voltage states recorded in the TDDB cell profile of the NAND2 cell. During time interval T2 between times t2 and t3, the input/output voltage state (A1, A2, ZN) is (1, 1, 0), which is within the valid input/output voltage states recorded in the TDDB cell profile of the NAND2 cell. During time interval T3 between times t3 and t4, the input/output voltage state (A1, A2, ZN) is (0, 0, 0), which is beyond the valid input/output voltage states recorded in the TDDB cell profile of the NAND2 cell. During time interval T4 between times t4 and t5, the input/output voltage state (A1, A2, ZN) is (0, 0, 1), which is within the valid input/output voltage states recorded in the TDDB cell profile of the NAND2 cell. Accordingly, the additional input/output voltage states (A1, A2, ZN)=(1, 1, 1) and (0, 0, 0) can be regarded as missing states with respect to the valid input/output voltage states recorded in the TDDB cell profile of the NAND2 cell.

For simplicity, the state duties corresponding to the input/output voltage states (A1, A2, ZN)=(0, 0, 1), (1, 1, 0), (1, 1, 1), and (0, 0, 0) are 40%, 40%, 10%, and 10%. When performing state mapping of the NAND gate #2, the EDA tool (e.g., processor 102) may first build the state mapping table shown in Table 8.

TABLE 8

| A1 | A2 | ZN | State Duty |
|---|---|---|---|
| 0 | 0 | 1 | 40% |
| 0 | 1 | 1 | 0% |
| 1 | 0 | 1 | 0% |
| 1 | 1 | 0 | 40% |
| 1 | 1 | 1 | 10% |
| 0 | 0 | 0 | 10% |

Referring to Table 8, the missing states (A1, A2, ZN)=(1, 1, 1) and (0, 0, 0) possess a cumulative state duty of 20%, potentially leading to a reduction in the derived FIT rate. In some embodiments, the EDA tool (e.g., processor 102) may use a first near-state algorithm to fix the missing states in the state mapping table shown in Table 8. The first near-state algorithm may utilize the least bit count modification method to transition from missing states to valid states, where the least bit count within the combination (A1, A2, ZN) refers to the bit of ZN. Specifically, the EDA tool (e.g., processor 102) may fix the missing states by modifying the output signal ZN, such as changing the combinations (A1, A2, ZN)=(1, 1, 1) and (0, 0, 0) to (1, 1, 0) and (0, 0, 1), respectively, thereby generating an intermediate state mapping table as shown in Table 9.

TABLE 9

| A1 | A2 | ZN | State Duty |
|---|---|---|---|
| 0 | 0 | 1 | 40% |
| 0 | 1 | 1 | 0% |
| 1 | 0 | 1 | 0% |
| 1 | 1 | 0 | 40% |
| 1 | 1 | 0 | 10% |
| 0 | 0 | 1 | 10% |

As can be seen from Table 9, states 5 and 6 are changed to (1, 1, 0) and (0, 0, 1) which are the same as states 4 and 1, respectively. Accordingly, the EDA tool can categorize states 5 and 6 into states 4 and 1, respectively. For example, the EDA tool may add the state duties of states 5 and 6 to those of states 4 and 1, respectively, and delete states 5 and 6 from Table 9, allowing the overall state duties of the fixed states 1 and 4 to be 50% and 50%, respectively, which is similar to Table 6.

In some embodiments, the EDA tool (e.g., processor 102) may use a second near-state algorithm to fix the missing states in the state mapping table shown in Table 8. The second near-state algorithm may modify one of the input or output signals (e.g., A1, A2, and ZN) within each missing state, thereby transitioning from missing states to valid states. Specifically, the EDA tool (e.g., processor 102) may fix the missing states by modifying one of the input signals A1 and A2 and the output signal ZN, such as changing the combinations (A1, A2, ZN)=(1, 1, 1) and (0, 0, 0) to (0, 1, 1) and (0, 0, 1), respectively, thereby generating an intermediate state mapping table as shown in Table 10.

TABLE 10

| A1 | A2 | ZN | State Duty |
|---|---|---|---|
| 0 | 0 | 1 | 40% |
| 0 | 1 | 1 | 0% |
| 1 | 0 | 1 | 0% |
| 1 | 1 | 0 | 40% |
| 0 | 1 | 1 | 10% |
| 0 | 0 | 1 | 10% |

As can be seen from Tables 8 and 10, the EDA tool modifies the input signal A1 in state 5 from 1 to 0, and modify the output signal ZN in state 6 from 0 to 1, indicating the modified states 5 and 6 shown in Table 10 are changed to (0, 1, 1) and (0, 0, 1) which are the same as states 2 and 1, respectively. Accordingly, the EDA tool can categorize states 5 and 6 into states 2 and 1, respectively. For example, the EDA tool may add the state duties of states 5 and 6 to those of states 2 and 1, respectively, and delete states 5 and 6 from Table 10, allowing the overall state duties of the states 1, 2, and 4 to be 50%, 10%, and 50%, as shown in Table 11.

TABLE 11

| A1 | A2 | ZN | State Duty |
|---|---|---|---|
| 0 | 0 | 1 | 50% |
| 0 | 1 | 1 | 10% |
| 1 | 0 | 1 | 0% |
| 1 | 1 | 0 | 40% |

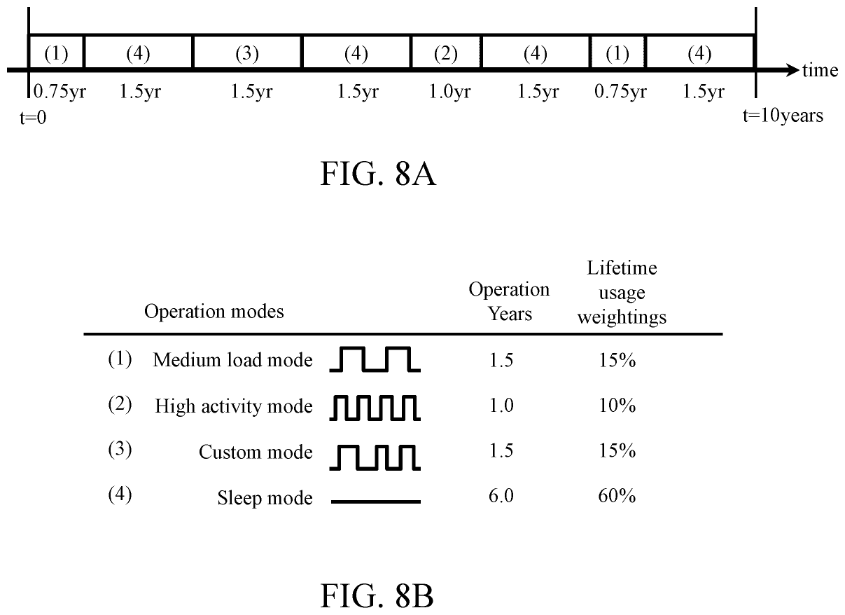

FIG. 8A is a diagram illustrating operations of an integrated circuit across a predetermined period in accordance with some embodiments of the present disclosure. FIG. 8B is a diagram illustrating different operation modes and corresponding operation years and usage weightings of the integrated circuit in accordance with the embodiment of FIG. 8A.

For purposes of description and simplicity, the integrated circuit has four operation modes, such as a medium load mode, a high activity mode, a custom mode, and a sleep mode, that are designated as operation modes (1), (2), (3), and (4), respectively, as shown in FIG. 8B. The time fragments of operation modes (1) to (4) may constitute a 10-year usage period, which is an expected lifetime of the integrated circuit, as shown in FIG. 8A. It should be noted that a real 10-year usage period could include much more time fragments of complicated mixed operation modes. Furthermore, it may be not feasible to generate a single operation vector (e.g., single operation mode) to represent the 10-year operation time of the integrated circuit.

Referring to FIG. 8B, the operation modes (1), (2), (3), and (4) may have cumulative operation times of 1.5 years, 1.0 year, 1.5 years, and 6.0 years and lifetime usage weightings of 15%, 10%, 15%, and 60%, respectively. For example, the lifetime usage weighting for each operation mode (1) to (4) can be calculated by dividing the cumulative operation time of each operation mode by the expected lifetime (e.g., 10 years) of the integrated circuit. Additionally, the sum of the lifetime usage weightings of operations modes (1) to (4) equal to 100%.

In some embodiments, when calculating an accurate FIT result across different operation modes, the EDA tool may record the state duty for each IMD within each cell at each operation mode under each failure mechanism. Additionally, the EDA tool may build a TDDB FIT result table for each operation mode of the integrated circuit. For simplicity, the FIT results for each operation mode (1) to (4) may include, but are not limited to, FIT_{VG-to-MD}, FIT_{VD-to-M0}, FIT_{MG-to-MD}, FIT_{M0-to-M}0, and Mode FITₛᵤₘ. Details of the relationships between different conductors, such as VG, MD, VD, M0, MG, etc., can be referred to FIGS. 3A-3B. For example, information about each operation mode (1) to (4) within the TDDB FIT result table may include lifetime usage (%), a waveform file, test duration, FIT_{VG-to-MD}, FIT VD-to-M0, FIT_{MG-to-MD}, FIT_{M0-to-M0}, and Mode FITₛᵤₘ. Additionally, the summation of FIT results of the integrated circuit can be computed by aggregating the Mode FITₛᵤₘ of each operation mode.

For simplicity, the integrated circuit includes N cells and Z M0-to-M0 IMDs, where N and Z are positive integers. The duty of each operation mode (1) to (4) can be designated as Duty_{Mode1}, Duty_{Mode2}, Duty_{Mode3}, and Duty_{Mode4}. For example, the duty of operation mode (1) can be expressed as Duty_{Mode1}=[duty_{1_1}, duty_{1_2}, . . . , duty_{1_Z}], where duty_{1_1} refers to the duty of the IMD object 1 in operation mode (1), duty_{1_2} refers to the duty of the IMD object 2 in operation mode (1), and so on. Similarly, the duties of operation modes (2) to (4) can be expressed as: Duty_{Mode2}=[duty_{2_1}, duty_{2_2}, duty_{2_Z}]; Duty_{Mode3}=[duty_{3_1}, duty_{3_2}, . . . , duty_{3_Z}]; and Duty_{Mode4}=[duty_{4_1}, duty_{4_2}, . . . , duty_{4_Z}], respectively.

In some embodiments, the EDA tool may calculate a weighted duty Duty_{IMD} of each IMD within the integrated circuit using equation (6) as follows.

$${Duty}_{IMD} = {\sum }_{k = 1}^{M} {Duty}_{Modek} * {Weight}_{k} \qquad ( 6 )$$

In equation (6), M is equal to 4 (i.e., 4 operation modes) for purposes of description, and the usage weightings of operation modes (1) to (4), designated as Weight₁ to Weight₄, as 15, 10, 15%, and 60%, respectively. Subsequently, the EDA tool may derive the chip-level M0-to-M0 FIT result (or other types of chip-level FIT results, such as VG to MD, VD to M0, MG to MD, etc.) based on the weighted duty Duty_{IMD} of each IMD within the integrated circuit.

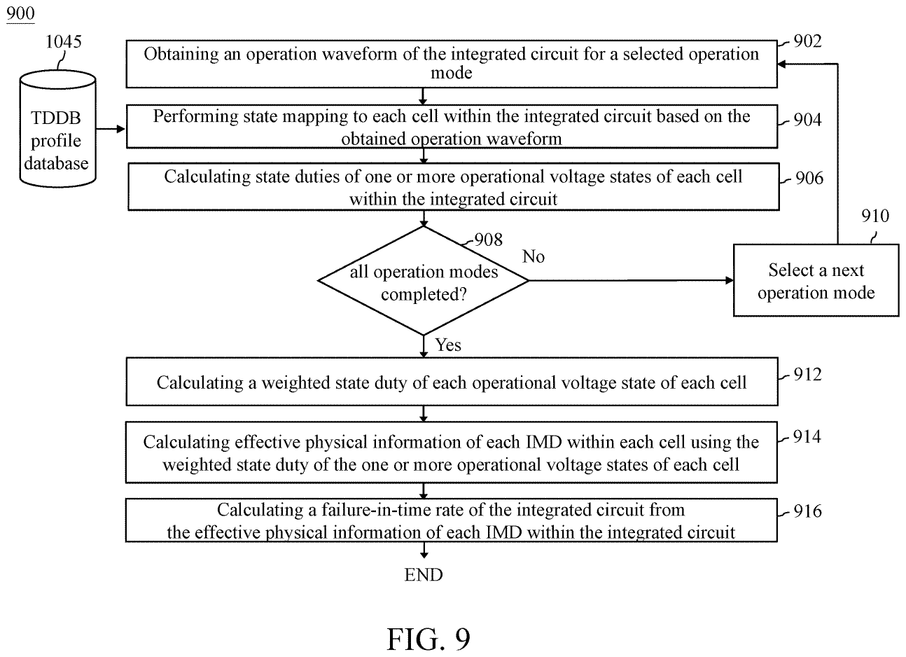

FIG. 9 is a flowchart of a method for calculating a failure-in-time (FIT) rate of an integrated circuit under multiple operation modes in accordance with some embodiments of the present disclosure. Referring to FIG. 9, the method 900 shown in FIG. 9 is similar to method 500 shown in FIG. 5, with the difference being that method 900 involves multiple operation modes of the integrated circuit, while method 500 involves a single operation mode of the integrated circuit. Additionally, operations 902 to 906 shown in FIG. 9 is similar to operations 510 to 530 shown in FIG. 5, the details of which are not repeated here.

Moreover, operations 902 to 906 are performed repeatedly for each selected operation mode until all operation modes of the integrated circuit 908 have been selected. For example, the EDA tool may determine whether all operation modes are completed (operation 908), and select a next operation mode (operation 910) when it is determined that not all operation modes are completed yet (operation 908: No). When it is determined that all operation modes are completed, operation 912 is performed. For example, when the operation mode (1) is selected, the state duties of operational voltage states of each cell can be derived from the operational waveform of each cell. These state duties can be collectively designated as Duty1_{n_k}, where n=1, 2, . . . , N, and k=1, 2, . . . , K. Similarly, when the operation mode (M) is selected (e.g., M=4), the state duties of operational voltage states of each cell can be derived from the operational waveform of each cell. These state duties can be collectively designated as DutyM_{n_k}, where n=1, 2, . . . , N, and k=1, 2, . . . , K.

Operation 912: calculating a weighted state duty of each operational voltage state of each cell. In some embodiments, the weighted state duty of each operational voltage state of each cell can be calculated by applying lifetime usage weightings (e.g., for different operation modes) to the state duties of the operational voltage states of each cell. It indicates that each operational voltage state of each cell may have a respective weighted duty, such as Duty_{n_k}, where n=1, 2, . . . , N, and k=1, 2, . . . , K.

Operation 914, calculating effective physical information of each inter-conductor dielectric within each cell using the weighted state duty of each operational voltage state of each cell. In some embodiments, the effective physical information may refer to the effective parallel-run length of each inter-conductor dielectric when the failure mechanism is associated with metal lines. Alternatively or additionally, the effective physical information may refer to the effective total count of via-to-metal (or metal-to-via) inter-conductor dielectrics when the failure mechanism is via-related.

Operation 916: calculating a failure-in-time rate of the integrated circuit from the effective physical information of each IMD within the integrated circuit. In some embodiments, the EDA tool may compute the summation of the effective physical information of each IMD within the integrated circuit, and derive the FIT rate from the summation of effective physical information using equation (1), the details of which can be referred to the embodiment of FIG. 5.

Accordingly, the method 900 shown in FIG. 9 facilitates the production flow to the cell library and IP/IC design. Furthermore, it enables precise calculation of the failure-in-time (FIT) rate for a circuit, an IP, or an integrated circuit based on actual operational waveforms. This capability allows for the identification of high FIT rate issues of cells, IPs, or ICs during the early design stages. Additionally, the method 900 provides the ability to delineate reliability margins between cells, IPs, and the integrated circuit. Furthermore, upon achieving an IC design with high reliability, the layout of the IC design can be forwarded to the foundry for fabrication.

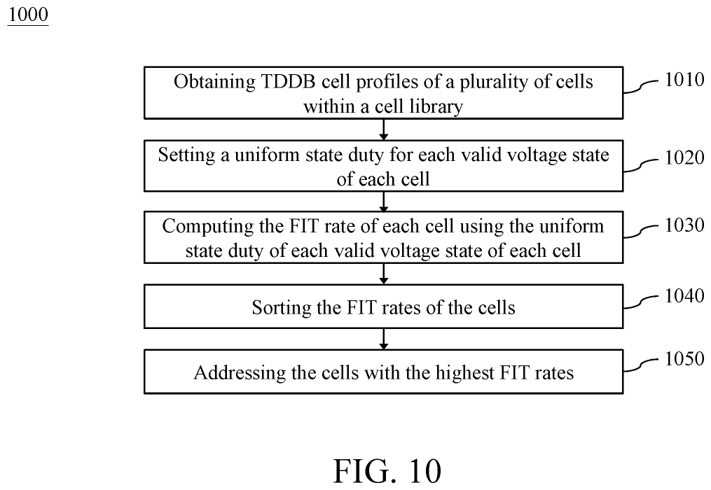

FIG. 10 is a flowchart of a method for performing TDDB benchmarking of cells within a cell library using the TDDB cell profiles in accordance with some embodiments of the present disclosure. In some embodiments, method 1000, which includes operations 1010 to 1050, may be employed to generate a benchmark of the FIT rate for each cell within a cell library. The process of method 1000 aids in identifying and addressing the top worst cells with the highest FIT rates that may raise potential TDDB failure risks.

Operation 1010: obtaining TDDB cell profiles of a plurality of cells within a cell library. In some embodiments, the TDDB cell profile of each cell within the cell library may be built using the method 200 shown in FIG. 2, the details of which are not repeated here.

Operation 1020: setting a uniform state duty for each valid voltage state of each cell. In some embodiments, since the TDDB cell profile of each cell may record all valid voltage states (e.g., valid input/output voltage states) of each cell, the EDA tool can set a uniform state duty for each valid input/output voltage state, indicating that each valid input/output voltage state maintains an equal state duty. For example, given that there are four valid input/output voltage states for a specific cell, each valid input/output voltage state maintains a state duty of 25%.

Operation 1030: computing the FIT rate of each cell using the uniform state duty of each valid voltage state of each cell. In some embodiments, the FIT rate of each cell can be computed using the method 500 shown in FIG. 5, with the difference being that the integrated circuit can be regarded as a single cell at operation 1030.

Operation 1040: Sorting the FIT rates of the cells. In some embodiments, once the FIT rate of each cell is computed, the EDA tool may organize the FIT rates of the cells, such as sorting them from the cell with the highest FIT rate to the cell with the lowest FIT rate. It should be noted that a higher FIT rate of a cell signifies a greater likelihood of failure over a specified target lifetime (e.g., 10 years).

Operation 1050: addressing the cells with the highest FIT rates. In some embodiments, the cells with the highest FIT rates may be considered as top worst cells within the cell library, potentially increasing the risk of TDDB failures. In such cases, various strategies may be employed to deal with these cells. For example, modifications to the layout and design (e.g., the arrangement of metal wires conveying input/output signals) may be implemented to reduce the FIT rates of these cells. Alternatively, these cells can be replaced by other cells that perform the same functions but possess lower FIT rates, or the use of these cells within the cell library is avoided during the design phase of the integrated circuit, such as by excluding these cells from the EDA tool or APR tool. Accordingly, the method 1000 can help to identify and address the cells with high FIT rates, thereby improving the design reliability of the integrated circuit during early design phase.

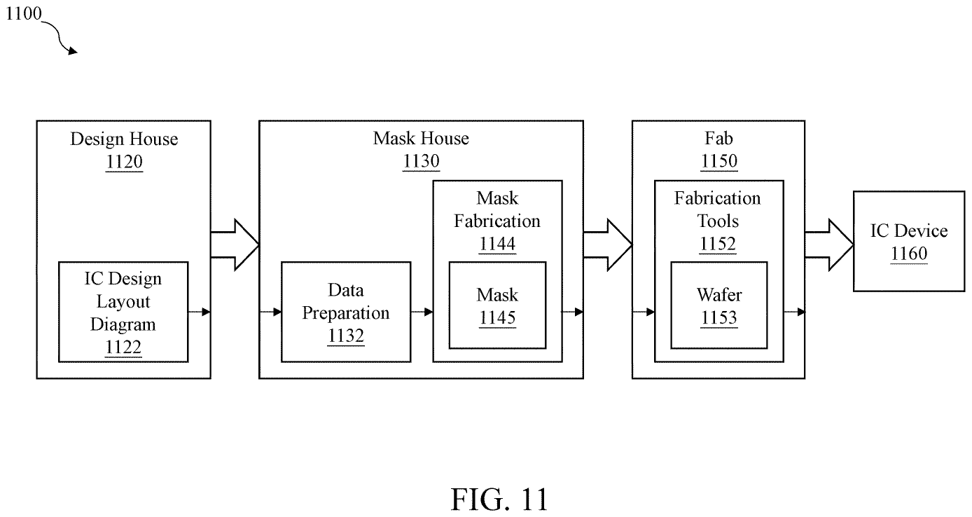

FIG. 11 is a block diagram of an IC manufacturing system 1100, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 1100.

In FIG. 11, IC manufacturing system 1100 includes entities, such as a design house 1120, a mask house 1130, and an IC manufacturer/fabricator (“fab”) 1150, that interact with one another in the design, development, and manufacturing cycles and/or services related to manufacturing an IC device 1160. The entities in system 1100 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1120, mask house 1130, and IC fab 1150 is owned by a single larger company. In some embodiments, two or more of design house 1120, mask house 1130, and IC fab 1150 coexist in a common facility and use common resources.

Design house (or design team) 1120 generates an IC design layout diagram 1122. IC design layout diagram 1122 includes various geometrical patterns, e.g., an IC layout diagram discussed above. The geometrical patterns correspond to patterns of metal, oxide, or semiconductor layers that make up the various components of IC device 1160 to be fabricated. The various layers combine to form various IC features. For example, a portion of IC design layout diagram 1122 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1120 implements a proper design procedure to form IC design layout diagram 1122. The design procedure includes one or more of logic design, physical design or place and route. IC design layout diagram 1122 is presented in one or more data files having information of the geometrical patterns. For example, IC design layout diagram 1122 can be expressed in a GDSII file format or DFII file format.

Mask house 1130 includes data preparation 1132 and mask fabrication 1144. Mask house 1130 uses IC design layout diagram 1122 to manufacture one or more masks 1145 to be used for fabricating the various layers of IC device 1160 according to IC design layout diagram 1122. Mask house 1130 performs mask data preparation 1132, where IC design layout diagram 1122 is translated into a representative data file (RDF). Mask data preparation 1132 provides the RDF to mask fabrication 1144. Mask fabrication 1144 includes a mask writer. A mask writer converts the RDF to an image on a substrate, such as mask (reticle) 1145 or a semiconductor wafer 1153. The design layout diagram 1122 is manipulated by mask data preparation 1132 to comply with particular characteristics of the mask writer and/or requirements of IC fab 1150. In FIG. 11, mask data preparation 1132 and mask fabrication 1144 are illustrated as separate elements. In some embodiments, mask data preparation 1132 and mask fabrication 1144 can be collectively referred to as mask data preparation.

In some embodiments, mask data preparation 1132 includes optical proximity correction (OPC) which uses lithography enhancement techniques to compensate for image errors, such as those that can arise from diffraction, interference, other process effects and the like. OPC adjusts IC design layout diagram 1122. In some embodiments, mask data preparation 1132 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1132 includes a mask rule checker (MRC) that checks the IC design layout diagram 1122 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1122 to compensate for limitations during mask fabrication 1144, which may undo part of the modifications performed by OPC in order to meet mask creation rules.

In some embodiments, mask data preparation 1132 includes lithography process checking (LPC) that simulates processing that will be implemented by IC fab 1150 to fabricate IC device 1160. LPC simulates this processing based on IC design layout diagram 1122 to create a simulated manufactured device, such as IC device 1160. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1122.

It should be understood that the above description of mask data preparation 1132 has been simplified for the purposes of clarity. In some embodiments, data preparation 1132 includes additional features such as a logic operation (LOP) to modify the IC design layout diagram 1122 according to manufacturing rules. Additionally, the processes applied to IC design layout diagram 1122 during data preparation 1132 may be executed in a variety of different orders.

After mask data preparation 1132 and during mask fabrication 1144, a mask 1145 or a group of masks 1145 are fabricated based on the modified IC design layout diagram 1122. In some embodiments, mask fabrication 1144 includes performing one or more lithographic exposures based on IC design layout diagram 1122. In some embodiments, an electron-beam (e-beam) or a mechanism of multiple e-beams is used to form a pattern on a mask (photomask or reticle) 1145 based on the modified IC design layout diagram 1122. Mask 1145 can be formed in various technologies. In some embodiments, mask 1145 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 1145 includes a transparent substrate (e.g., fused quartz) and an opaque material (e.g., chromium) coated in the opaque regions of the binary mask. In another example, mask 1145 is formed using a phase shift technology. In a phase shift mask (PSM) version of mask 1145, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1144 is used in a variety of processes. For example, such a mask(s) is used in an ion implantation process to form various doped regions in semiconductor wafer 1153, in an etching process to form various etching regions in semiconductor wafer 1153, and/or in other suitable processes.

IC fab 1150 is an IC fabrication business that includes one or more manufacturing facilities for the fabrication of a variety of different IC products. In some embodiments, IC Fab 1150 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1150 includes wafer fabrication tools 1152 configured to execute various manufacturing operations on semiconductor wafer 1153 such that IC device 1160 is fabricated in accordance with the mask(s), e.g., mask 1145. In various embodiments, fabrication tools 1152 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1150 uses mask(s) 1145 fabricated by mask house 1130 to fabricate IC device 1160. Thus, IC fab 1150 at least indirectly uses IC design layout diagram 1122 to fabricate IC device 1160. In some embodiments, semiconductor wafer 1153 is fabricated by IC fab 1150 using mask(s) 1145 to form IC device 1160. In some embodiments, the IC fabrication includes performing one or more lithographic exposures based at least indirectly on IC design layout diagram 1122. Semiconductor wafer 1153 includes a silicon substrate or other proper substrate having material layers formed thereon. Semiconductor wafer 1153 further includes one or more of various doped regions, dielectric features, multilevel interconnects, and the like (formed at subsequent manufacturing steps).

An aspect of the present disclosure provides a method which includes the following steps: obtaining an operation waveform of an integrated circuit which includes a plurality of cells; performing state mapping to each cell within the integrated circuit based on the obtained operation waveform; calculating state duties of one or more operational voltage states of each cell within the integrated circuit; calculating effective physical information of each inter-conductor dielectric within each cell using the state duties of the one or more operational voltage states of the respective cell; and calculating a failure-in-time rate of the integrated circuit from the effective physical information of each inter-conductor dielectric within each cell.

Another aspect of the present disclosure provides a method which includes the following steps: obtaining an operation waveform of an integrated circuit which includes a plurality of cells for each of a plurality of operation modes of the integrated circuit; performing state mapping to each cell within the integrated circuit based on the obtained operation waveform to obtain one or more operational voltage states of each cell for each operation mode; calculating state duties of the one or more operational voltage states of each cell within the integrated circuit for each operational mode; calculating a weighted state duty of each operational voltage state of each cell; calculating effective physical information of each inter-conductor dielectric within each cell using the weighted state duty of each operational voltage state of each cell; and calculating a failure-in-time rate of the integrated circuit from the effective physical information of each inter-conductor dielectric within each cell.

Yet another aspect of the present disclosure provides a method which includes the following steps: obtaining a time-dependent dielectric breakdown cell profile of a plurality of cells within a cell library, where each time-dependent dielectric breakdown cell profile records a plurality of valid voltage states; setting a uniform state duty for each valid voltage state of each cell; computing a failure-in-time rate of each cell using the uniform state duty of each valid voltage state of each cell; sorting the failure-in-time rates of the cells; and addressing the cells with the highest failure-in-time rates.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method, comprising:
obtaining, by a processor, an operation waveform of an integrated circuit which comprises a plurality of cells for each of a plurality of operation modes;
performing, by the processor, state mapping to each cell within the integrated circuit based on the obtained operation waveform to obtain one or more operational voltage states of each cell for each operation mode;
calculating, by the processor, state duties of the one or more operational voltage states of each cell within the integrated circuit for each operation mode;
calculating, by the processor, a weighted state duty of each operational voltage state of each cell by applying a lifetime usage weighting for each operation mode to the corresponding state duties;
calculating, by the processor, effective physical information of each inter-conductor dielectric within each cell using the weighted state duty of each operational voltage state of each cell; and
calculating, by the processor, a failure-in-time (FIT) rate of the integrated circuit from the effective physical information of each inter-conductor dielectric within each cell.

2. The method of claim 1, wherein the performing state mapping to each cell within the integrated circuit based on the obtained operation waveform to obtain one or more operational voltage states of each cell comprises:
obtaining a time-dependent dielectric breakdown (TDDB) cell profile of each cell, which records valid voltage states of each cell;
generating an internal operation waveform for each cell from the operation waveform of the integrated circuit; and
mapping the valid voltage states to the one or more operational voltage states of each cell from the internal operation waveform for each cell,
wherein each operational voltage state of each cell is a valid voltage state with a state duty exceeding 0%.

3. The method of claim 2, wherein the TDDB cell profile of each cell further records a stress voltage and a stress direction thereof, and physical information of each inter-conductor dielectric within each cell.

4. The method of claim 3, further comprising:
computing the state duty of each operational voltage state of each cell; and
converting the physical information to the effective physical information of each cell using the state duty of each operational voltage state of each cell.

5. The method of claim 4, wherein the effective physical information denotes an effective parallel-run length of metal wires along opposite sides of each inter-conductor dielectric within each cell when a failure mechanism of the integrated circuit is associated with metal lines within the integrated circuit.

6. The method of claim 5, wherein the integrated circuit comprises a plurality of metal layers, each layer comprising a plurality of metal wires disposed thereon, and each metal wire has a respective drawing physical length on the respective metal layer within a layout of the integrated circuit.

7. The method of claim 6, wherein in response to a stress voltage of a particular inter-conductor dielectric is a direct-current (DC) voltage, the effective parallel-run length of the metal wires along opposite sides of the particular inter-conductor dielectric equals the drawing physical length.

8. The method of claim 6, further comprising: in response to a stress voltage of a particular inter-conductor dielectric is an alternating-current (AC) voltage, calculating a weighted parallel-run length as the effective parallel-run length by multiplying the parallel-run length with a respective AC-effect scaling factor of each operational voltage state inducing non-zero stress voltage to the particular inter-conductor dielectric, wherein the respective AC-effect scaling factor of each operational voltage state corresponds to the state duty of each operational voltage state.

9. The method of claim 3, wherein the effective physical information denotes an effective total count of via-to-metal dielectrics among the inter-conductor dielectrics when a failure mechanism of the integrated circuit is via-related.

10. The method of claim 1, wherein the calculating the failure-in-time rate of the integrated circuit from the effective physical information of each inter-conductor dielectric within each cell comprises:
computing a summation of the effective physical information of each inter-conductor dielectric within the integrated circuit; and
calculating the failure-in-time rate of the integrated circuit from the summation of the effective physical information of each inter-conductor dielectric.

11. The method of claim 2, further comprising:
when one or more additional voltage states, which are beyond the valid voltage states recorded in the TDDB cell profile of each cell, are obtained during the state mapping, performing a near-state algorithm to change one bit of each additional voltage state to fix the respective additional voltage state to one of the valid voltage states of each cell; and
categorizing each fixed additional voltage state to one of the valid voltage states of each cell.

12. The method of claim 11, wherein the changed bit is an input signal bit or an output signal bit within each additional voltage state.

13. A non-transitory computer-readable medium having stored thereon computer-readable instructions that, when executed by a processor, cause the processor to execute a method, the method comprising:
obtaining an operation waveform of an integrated circuit which comprises a plurality of cells for each of a plurality of operation modes;
performing state mapping to each cell within the integrated circuit based on the obtained operation waveform for each operation mode to obtain one or more operational voltage states of each cell for each operation mode;
calculating state duties of the one or more operational voltage states of each cell for each operation mode;
calculating a weighted state duty of each operational voltage state by applying an operation-mode lifetime usage weighting to the corresponding state duties; and
calculating effective physical information of each inter-conductor dielectric within each cell using the weighted state duty of each operational voltage state of each cell; and
deriving a failure-in-time rate of the integrated circuit from the effective physical information.

14. The non-transitory computer-readable medium of claim 13, wherein the performing state mapping to each cell within the integrated circuit based on the obtained operation waveform for each operation mode to obtain one or more operational voltage states of each cell for each operation mode comprises:
obtaining a time-dependent dielectric breakdown (TDDB) cell profile of each cell, which records valid voltage states of each cell;
generating an internal operation waveform for each cell from the obtained operation waveform of the integrated circuit for each operational mode; and
mapping the valid voltage states to the one or more operational voltage states of each cell from the internal operation waveform for each cell for each operation mode,
wherein each operational voltage state of each cell is a valid voltage state with a state duty exceeding 0%.

15. The non-transitory computer-readable medium of claim 14, wherein the TDDB cell profile of each cell further records a stress voltage and a stress direction thereof, and physical information of each inter-conductor dielectric within each cell.

16. The non-transitory computer-readable medium of claim 13, wherein the calculating weighted state duties of the one or more operational voltage states of each inter-conductor dielectric within each cell comprises:
calculating a lifetime usage weighting for each operation mode by dividing a respective cumulative operation time of each operation mode by an expected lifetime of the integrated circuit; and
calculating the weighted state duty of each operational voltage state of each cell by applying a lifetime usage weighting for each operation mode to the state duty of each operational voltage states of each cell.

17. The non-transitory computer-readable medium of claim 13, wherein:
the effective physical information denotes an effective parallel-run length of metal wires along opposite sides of each inter-conductor dielectric within each cell when a failure mechanism of the integrated circuit is associated with metal lines within the integrated circuit; and
the effective physical information denotes an effective total count of via-to-metal dielectrics among the inter-conductor dielectrics when a failure mechanism of the integrated circuit is via-related.

18. A system comprising a non-transitory computer-readable medium storing program instructions; and a processor operatively coupled to the non-transitory computer-readable medium, wherein the program instructions, when executed by the processor, cause the processor to:
obtain time-dependent dielectric breakdown (TDDB) cell profiles of a plurality of cells within a cell library;
set a uniform state duty for each valid voltage state of each cell;
compute a failure-in-time (FIT) rate for each cell using the uniform state duty of each valid voltage state of each cell;
sort the failure-in-time rates of the cells; and
automatically flag or mark the cells whose failure-in-time rates exceed a predetermined FIT threshold for further layout modification or exclusion from library use.

19. The system of claim 18, wherein each cell comprises a plurality of inter-conductor dielectrics, and the TDDB cell profile of each cell further records a stress voltage and a stress direction thereof, and physical information of each inter-conductor dielectric within each cell.

20. The system of claim 19, wherein the program instructions, when executed by the processor, cause the processor to:
computing a state duty of each operational voltage state of each cell; and
converting the physical information to effective physical information of each cell using the state duty of each operational voltage state of each cell,
wherein the effective physical information denotes an effective parallel-run length of metal wires along opposite sides of each inter-conductor dielectric within each cell when a failure mechanism of the integrated circuit is associated with metal lines within the integrated circuit.
